(19) United States
(12) Patent Application Publication
(10) Pub. No.: US 2011/0138382 A1
(43) Pub. Date: Jun. 9, 2011

(54) SYSTEM AND METHOD FOR LOADING RESOURCES INTO A VIRTUAL MACHINE

(75) Inventors: Robert R. Hauser, Frisco, TX (US); Thomas T. Wheeler, Frisco, TX (US); Robert W. Peterson, Plano, TX (US); Deren G. Ebdon, Carrollton, TX (US)

(73) Assignee: RECURSION SOFTWARE, INC., Frisco, TX (US)

(21) Appl. No.: 12/629,940

(22) Filed: Dec. 3, 2009

(51) Int. Cl. G06F 9/455

(52) U.S. Cl. 718/1

(57) ABSTRACT

In a heterogeneous environment of virtual machines, an agent can migrate between virtual machines of different types. During migration, classes of the mobile agent may need to be instantiated on the new virtual machine. To support classes across all virtual machine types, a resource server is provided that can provide virtual machine type specific instances of the classfile. The resource server receives a resource request from a resource loader of a virtual machine. The resource request specifies the resource and the virtual machine type, thereby enabling the resource server to retrieve the correct instance of the classfile to return to the resource loader.

### FIELD OF THE INVENTION

This disclosure relates to virtual machines and in particular to migrating agents across virtual machines of different types.

### BACKGROUND OF THE INVENTION

In a Virtual Machine (VM) environment (e.g. Java, .NET etc) dynamic needs often require loading a new type, e.g. a new class in Java. Bringing a new class into the VM is handled by a resource loader that is responsible for finding the correct classfile for the new class and loading that classfile into the VM. Typically, the resource loaders are configured to load classfiles from VM specific resource servers. That is, there is a different resource server for each VM type. This can create problems in a heterogeneous environment because there is no single source for handling dynamic classfile needs, e.g. such as when a new mobile agent arrives at a VM.

What is required is an improved system and method for providing resources to virtual machines.

### SUMMARY OF THE INVENTION

In one aspect of the disclosure, there is provided a method for obtaining a resource for use in a virtual machine. The method comprises determining at least one resource requirement in the virtual machine, providing a connection to a resource server, identifying a virtual machine type to the resource server, identifying the at least one resource requirement to the resource server, and receiving at least one resource corresponding to the virtual machine type from the resource server.

In one aspect of the disclosure, there is provided a resource server configured to communicate with a plurality of virtual machines of a plurality of virtual machine types, and provide virtual machine type specific resources to the plurality of virtual machines.

In one aspect of the disclosure, there is provided a computer-readable medium comprising computer-executable instructions for execution by at least one processor, that, when executed, cause the at least one processor to execute a virtual machine, receive a serialized stream comprising one or more classes, deserialize the serialized stream, obtain a resource server address from the serialized stream, generate a class request for at least one of the one or more classes, the class request indicating a type of the virtual machine, and cause the class request to be transmitted to a resource server at the resource server address.

### BRIEF DESCRIPTION OF THE DRAWINGS

Reference will now be made, by way of example only, to specific embodiments and to the accompanying drawings in which:

FIG. 1 illustrates a system of virtual machines;

FIG. 2 illustrates a method for obtaining resources for a virtual machine;

FIG. 3 illustrates a process of a resource loader;

FIG. 4 illustrates migration of a mobile agent between virtual machines of different types;

FIG. 5 illustrates migration of a mobile agent which includes a resource server address;

FIG. 6 illustrates a process for instantiating the mobile agent of FIG. 5;

FIG. 7 illustrates a process for processing a remote resource server queue in the resource loader;

FIG. 8 illustrates a processor and memory of a virtual machine;

FIG. 9 illustrates an instruction set executable on the processor of FIG. 8; and

FIG. 10 illustrates the processor and memory of the virtual machine in communication with a processor of a resource request handler.

### DETAILED DESCRIPTION OF THE INVENTION

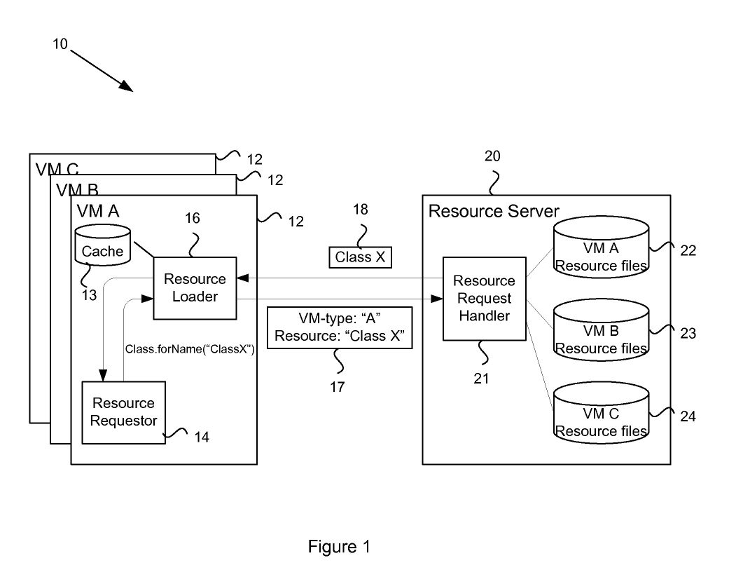

In FIG. 1, there is shown a system 10 that includes a number of virtual machines 12, shown as VM A, VM B and VM C. The VMs 12 represent different types of VMs, i.e. VMs that operate on different bytecode such as, without limitation, Java4, Java6, .NET CLR 2.0, Android Dalvik, etc. Each VM 12 includes a resource requestor 14 and resource loader 16.

Provided in the system 10 is a resource server 20. The resource server includes a resource request handler 21 and data storage for storing resource files for VM type A 22, VM type B 23 and VM type C 24. Data storage for other VM types may also be provided. The data storage may be amalgamated into a single data storage or may be provided in some distributed form. The resource server 20 may itself run in a virtual machine of the same type as any of VM A, VM B or VM C or in any other VM type. The resource server may also run in a non-VM environment. In one embodiment, one or more of the data storages 22, 23, 24 may be offsite data storage that the resource request handler accesses through an appropriate network. The resource request handler includes an addressing system that identifies where the resource files for different types of virtual machines can be found.

The resource files stored in the storages 22, 23, 24 may be VM-specific because they hold byte code that is VM-specific (e.g. Java class files for Java virtual machines). A resource can be a single item (e.g. a file containing a class) or a collection of items which may be an archive containing several files (e.g. a jar file, an OSGi bundle, a .NET assembly).

A communication protocol is defined for communications between the virtual machines 12 and the resource server 20 that specifies how resources are to be requested. Specifically, a resource request 17 from a virtual machine 12 will identify a requested resource as well as the type of the virtual machine that is making the request. The resource request handler 21 is thus able to process the resource request 17 and retrieve the requested resource from the resource file storage of the appropriate type. The resource request handler 21 responds to the resource loader with a response 18 including the requested resource. In one embodiment, communication from the virtual machines 12 to the resource server 20 will typically be a serialized binary stream however any suitable protocol may be used, of which HTTP, RMI, SOAP/XML, Binary XML are some examples.

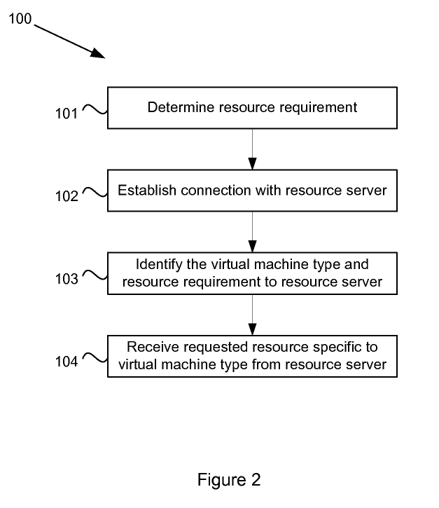

A method for loading resources into the virtual machine is shown in the flowchart 100 of FIG. 2. At step 101, the virtual machine 12 determines a resource requirement. At step 102, the virtual machine makes a connection to a resource server 20 and identifies the virtual machine type and the resource requirement to the resource server 20 (step 103). The virtual machine then receives the requested resource corresponding to the virtual machine type from the resource server (step 104). FIG. 1 shows a request for VM A resource, e.g., a Java resource, identified as Class X 17. The resource request handler 21 retrieves the requested class from the storage 22 which stores VM A (Java) classfiles and returns Class X 18 to the resource loader 16. Resources may be returned as stand alone files, archives, or in any appropriate form that can be processed by the resource loader.

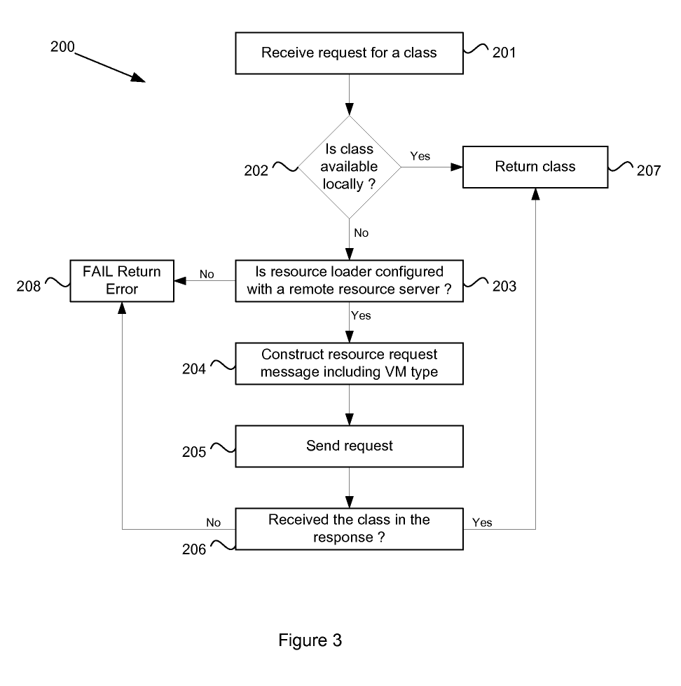

A method of operation of the resource loader is illustrated in the flowchart 200 of FIG. 3 with specific reference to loading Java classes. It will be understood that non-Java resources may be used with the same method. At step 201, the resource loader 16 receives a class request from the class requestor 14. For example, the class request may arise as a result of deserialization of a received serialized object stream. If the resource loader 16 determines at step 202 that the class is available locally, e.g. from cache 13, then the class is returned to the class requestor 14 at step 207. Otherwise, if the resource loader is not configured with a remote resource loader, as determined at step 203, then the resource loader 16 returns a Fail Return Error (step 208). If the resource loader 16 is configured with a remote resource server 20, then the resource loader 16 proceeds to construct a resource request 17 to the resource server 20 (step 204). In the present example, the class request is for “Class X” from a type A virtual machine (e.g. Java VM). The request 17 is sent at step 205. If the resource loader 16 receives the requested resource in the response message 18 from the resource server 20, received at step 206, then the class is returned to the class requestor at step 207. Otherwise, a Fail Return Error is returned to the class requester 208.

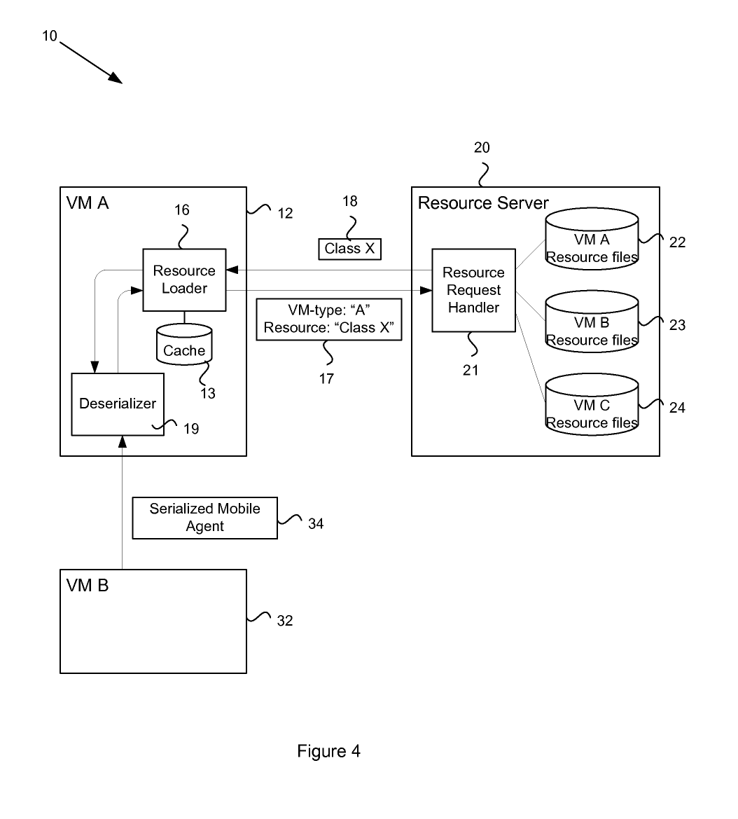

In one embodiment illustrated in FIG. 4, the class requestor 14 may be considered to be a deserializer 19. For example, a mobile agent 34 executing on VM B 32 may be serialized and migrate to VM A 12 across a network. In this example, the deserializer 19 of VM A 12 needs Class X for instantiating the incoming mobile agent 34 and so requests the Class X classfile from the resource loader 16. The resource loader 16 generates a resource request that requests the Class X classfile for a type A virtual machine.

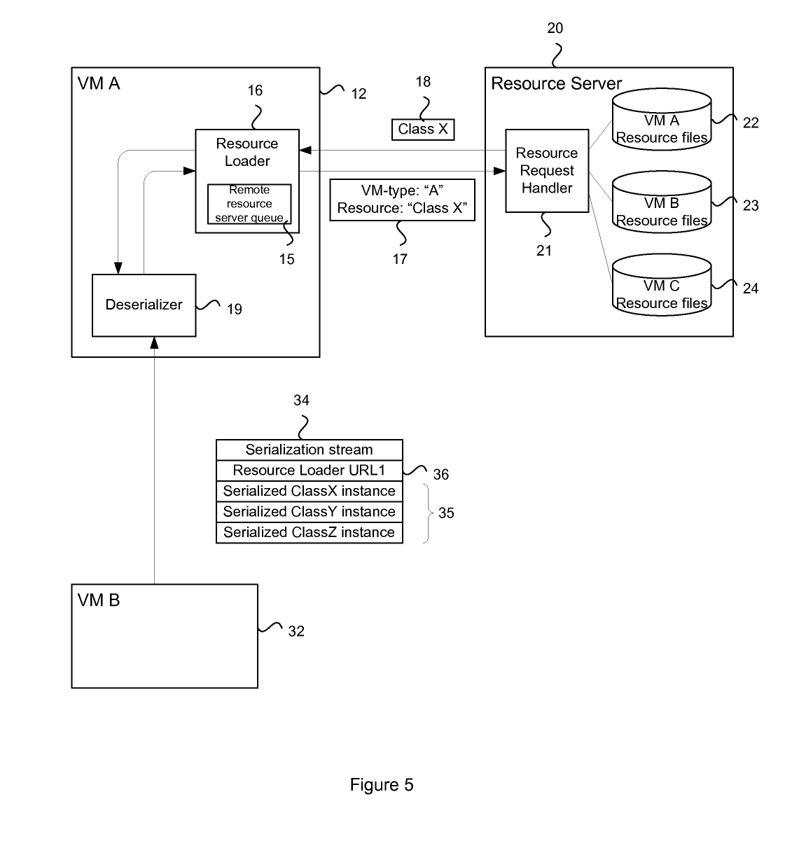

In FIG. 5 there is shown a modified system in which a serialized stream 34 from virtual machine B 32 includes the serialized class instances 35 that form mobile agent 34. In this example, the mobile agent includes class instances ClassX, ClassY and ClassZ. In addition to the serialized mobile agent 35, the serialized stream 34 includes a resource server URL 36 “URL1” that provides an indicator to the resource server 20 from which the class instances can be retrieved.

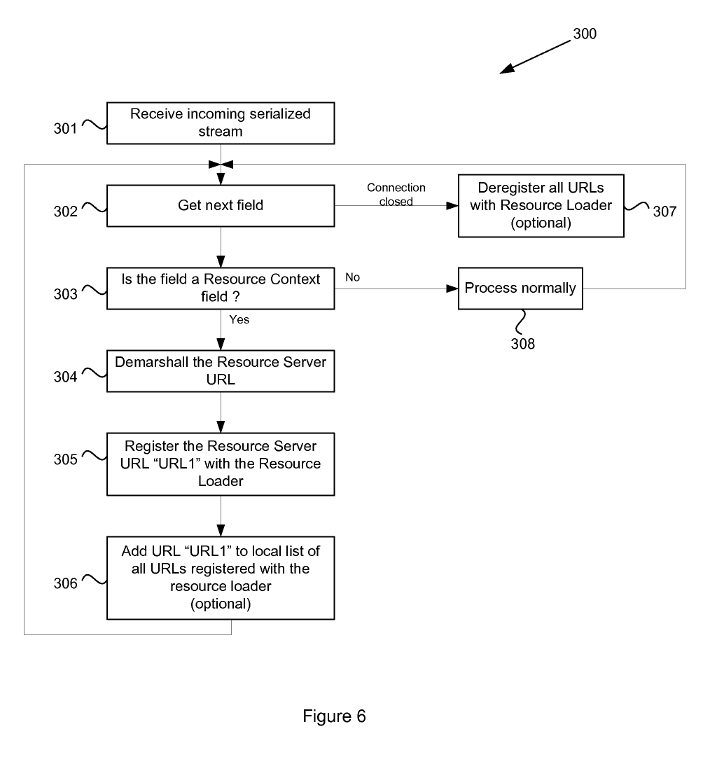

The process for instantiating the mobile agent 34 may be as illustrated in the flowchart 300 of FIG. 6. At step 301, the serialized stream 34 is received into the deserializer of VM A 12. Deserializing of the stream 34 commences by getting a first field of the stream 34 (step 302). A determination step 303 determines if the field is a Resource Context field. If the field is not a Resource Context field, the field is processed normally (step 308) and the process returns to step 302 where the next field is processed. If the field is determined to be a Resource Context field 36 at step 303, then the deserializer 19 demarshalls the value of the resource loader URL, e.g. “URL1”. The deserializer 19 then registers the Resource Loader URL with the Resource Loader 16. The Resource Loader 16 may register the URL by receiving the URL from the deserializer 19 and adding the URL to a remote resource server queue 15. As an optional step 306, the URL may be added to a local list of all URLs registered with the resource loader.

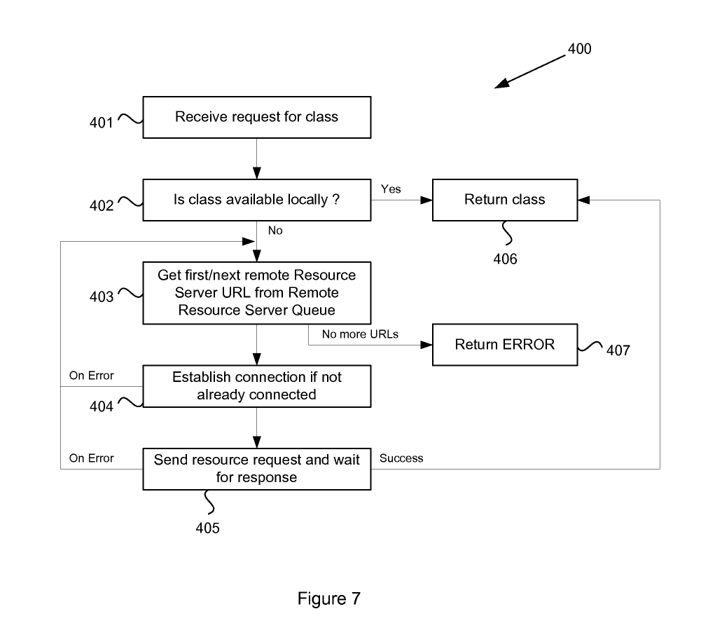

Normal processing as shown at step 308 includes instantiation of classes, for example by Class.forName( ) calls to the resource loader. FIG. 7 shows a process 400 performed when the resource loader 16 receives such requests from the deserializer 19. The request for a class is received at step 401. The resource loader will typically cache remotely retrieved class files and so if the class is available locally, as determined at step 402, then the class is returned to the deserializer at step 406. Otherwise, the resource loader processes the remote resource server queue 15 to retrieve the requested class remotely. Because the most likely candidate to successfully supply the requested class is the last registered URL, the queue 15 may be a last-in-first-out (LIFO) queue though other systems for storing the potential URLs will be apparent to the skilled addressee. The resource loader 16 processes the queue 15 by selecting a first or next Resource Server URL from the queue (step 403). If no connection from the resource loader 16 to the server identified by the selected URL exists, then a connection is established at step 404. The resource request 17 identifying the requested resource and the virtual machine type is sent to the selected server 20. If the requested resource is not successfully returned, then the queue processing returns to step 403 where a next URL is selected from the queue 15. If the requested resource is successfully supplied by the server, then the resource loader 16 returns the class to the deserializer 19 at step 406.

Using a stateful connection between the resource loader 16 and the resource server 20, as opposed to a stateless approach, the “VM_type:” field and value may be sent in the connect message rather than in the resource request message.

Once the mobile agent has been properly instantiated on the virtual machine to which the agent has migrated, any URLs required to instantiate the mobile agent, e.g. URL1, may optionally be deregistered from the remote resource server queue 15.

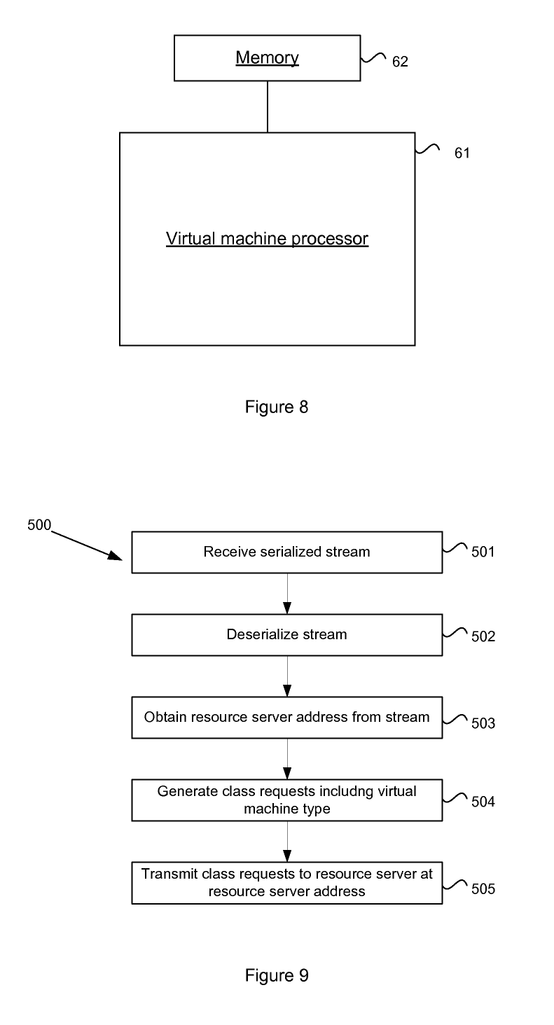

The components of the system 10 may be embodied in hardware, software, firmware or a combination of hardware, software and/or firmware. In a hardware embodiment, the virtual machine 12 may be executed on a processor 61 operatively associated with a memory 62 as shown in FIG. 8. The memory 62 may store instructions that are executable on the processor 61. An instruction set 500 that may be executed on the processor 61 is depicted in the flowchart of FIG. 8. Specifically, when executed, the instruction set 500 allows the processor 61 to receive a serialized stream (step 501) comprising one or more classes and to deserialize the stream (step 502). The processor 61 obtains a resource server address from the serialized stream (step 503). If any of the classes from the stream require instantiating in the virtual machine, the processor 61 generates a class request (step 504) that includes an identity of the virtual machine type. The processor then causes the class request to be transmitted to a resource server at the resource server address (step 505).

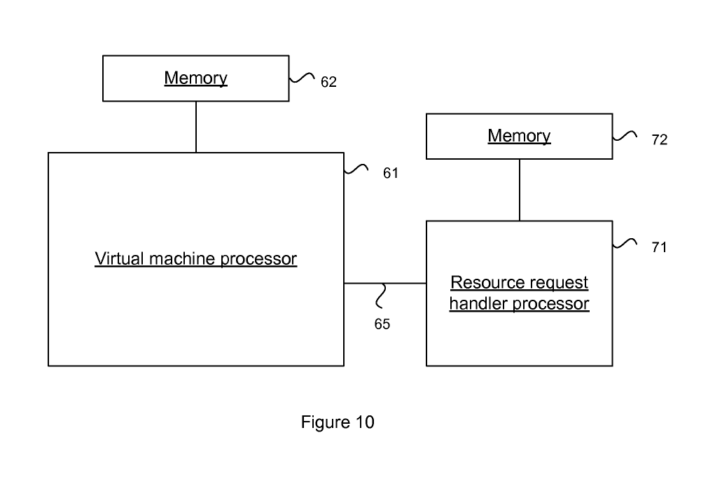

As shown in FIG. 10, the processor 61 may communicate through a suitable communications link 65 with further processors, such as a processor 71 of a resource request handler 21 with associated memory 72. Through the communications link 65, the processor 61 may provide the class requests. At the resource request handler end, the processor 71 may receive a class request and determine the virtual machine type of the requestor. The processor 71 may then look up the memory 72 to determine a location at which the requested class is stored for the particular virtual machine type.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

1. A method, comprising:
determining at least one resource associated with a virtual machine;
identifying a virtual machine type associated with the virtual machine to a resource server;
requesting the at least one resource associated with the virtual machine type from the resource server; and
receiving the at least one resource corresponding to the virtual machine type from the resource server in response to requesting the at least one resource associated with the virtual machine type from the resource server.

2. The method according to claim 1, further comprising providing a connection to the resource server before identifying the virtual machine type to the resource server.

3. The method according to claim 1, comprising:
generating a resource request configured to identify the at least one resource and the virtual machine type; and
providing the resource request to the resource server.

4. (canceled)

5. The method according to claim 3, wherein the resource server is configured to determine the virtual machine type from the resource request.

6. The method according to claim 3, wherein the resource server is configured to determine the virtual machine type during a connection process between the virtual machine and the resource server.

7. The method according to claim 2, further comprising:
receiving a serialized stream comprising at least one serialized object;
deserializing the serialized stream; and
instantiating the at least one serialized object in the virtual machine in response to receiving the at least one resource from the resource server.

8. The method according to claim 7, further comprising:
providing a connection to the resource server in response to a resource server address from the serialized stream.

9. The method according to claim 8, further comprising registering the resource server address with a resource loader of the virtual machine.

10. The method according to claim 9, comprising:
determining the at least one resource in the resource loader;
retrieving the resource server address from the serialized stream; and
providing the resource request to the resource server associated with the resource server address retrieved from the serialized stream.

11. A resource server, comprising:
a storage device configured to store a plurality of resource files associated with a plurality of virtual machines having a corresponding plurality of types; and
a resource request handler configured to retrieve at least one resource file for a type of virtual machine from the storage device in response to a request configured to identify the at least one resource file and the type of the virtual machine making the request.

12. The resource server according to claim 11, wherein the resource request handler is further configured to:
determine the type of the virtual machine from the request; and
provide an instance of the at least one resource file that corresponds to the type of the virtual machine.

13. The resource server according to claim 12,
wherein the storage device comprises at least one database; and
wherein the resource handler is configured to store an address corresponding to the at least one database.

14. The resource server according to claim 13, wherein the at least one database is configured to associate the at least one resource with the type of the virtual machine.

15. The resource server according to claim 13, wherein the at least one database is configured to store a plurality of instances of a classfile, each instance of a classfile corresponding to a type of virtual machine.

16. (canceled)

17. The resource server according to claim 12, wherein the resource request handler is configured to determine the type of the virtual machine from a connection with the virtual machine.

18. A computer-readable storage device comprising computer-executable instructions stored thereon that configure a processing device to perform operations comprising:
receiving a serialized stream comprising at least one object;
deserializing the serialized stream;
obtaining an address for a resource server from the serialized stream;
generating a class request for a class associated with the at least one object, the class request indicating a type of the virtual machine generating the request; and
transmitting the class request to a resource server at the address for the resource server.

19. The computer-readable storage device of claim 18, wherein the processing device is configured to perform operations further comprising registering the address for the resource serve with a resource loader.

20. The computer-readable storage device of claim 19, wherein the processing device is configured to perform operations further comprising:
retrieving, from the resource loader, a first address for a first resource server;
transmitting the class request to the first resource server at the first address;
retrieving, from the resource loader, a second address for a second resource server in response to the first resource server failing to return the class; and
transmitting the class request to a second resource server at the second address.

21. A device, comprising:
a cache configured to store a plurality of resources corresponding to a plurality of virtual machines;
a resource requestor configured to generate a request for at least one resource corresponding to at least one virtual machine; and
a resource loader configured to transmit the request for the at least one resource to a resource server in response to the at least one resource not being available in the cache;
wherein the request is configured to identify the at least one resource and a type associated with the at least one virtual machine.

22. The device of claim 21, wherein the resource loader is further configured to retrieve the at least one resource from the cache in response to the at least one resource being available in the local cache.

23. The device of claim 22, wherein the resource loader is further configured to:
receive a serialized stream comprising at least one object;
deserialize the serialized stream; and
instantiate the at least one object in the virtual machine in response to receiving the least one resource from the resource server or in response to retrieving the at least one resource from the cache.

24. The device of claim 21, wherein the resource loader is further configured to establish a connection with the resource server and further configured to use the connection to transmit the request for the at least one resource to the resource server.

25. The device of claim 24, wherein the resource loader is further configured to determine an address of the resource server from the serialized stream.

26. The device of claim 25, wherein the resource loader is further configured to register the address of the resource server.

27. A method, comprising:
receiving a request from at least one virtual machine, the request identifying at least one resource associated with the at least one virtual machine and identifying a type associated with the at least one virtual machine;
retrieving the at least one resource according to the type of the at least one virtual machine from a storage device; and
transmitting the at least one resource to the at least one virtual machine.

28. The device of claim 27, wherein the storage device comprises at least one database configured to associate a plurality of virtual machine types with a corresponding plurality of virtual machines.

29. The device of claim 27, further comprising storing an address of the at least one virtual machine.

30. The device of claim 27, wherein the storage device comprises at least one database configured to store a plurality of instances of a classfile, each instance of a classfile corresponding to a type of virtual machine.

31. A computer-readable storage device comprising computer-executable instructions stored thereon that configure a processing device to perform operations comprising:
receiving a request from at least one virtual machine, the request identifying at least one resource associated with the at least one virtual machine and identifying a type associated with the at least one virtual machine;
retrieving the at least one resource according to the type of the at least one virtual machine from a storage device; and
transmitting the at least one resource to the at least one virtual machine.

32. The computer-readable storage device of claim 31, wherein the storage device comprises at least one database configured to associate a plurality of virtual machine types with a corresponding plurality of virtual machines.

33. The computer-readable storage device of claim 31, wherein the processing device is configured to perform operations further comprising storing an address of the at least one virtual machine.

34. The computer-readable storage device of claim 31, wherein the storage device comprises at least one database configured to store a plurality of instances of a classfile, each instance of a classfile corresponding to a type of virtual machine.
